(19) United States
(12) Patent Application Publication
(10) Pub. No.: US 2012/0146957 A1
(43) Pub. Date: Jun. 14, 2012

(54) STYLUS TIP DEVICE FOR TOUCH SCREEN

(76) Inventor: Kelly Allan Dunagan, La Habra, CA (US)

(21) Appl. No.: 12/963,997

(22) Filed: Dec. 9, 2010

(51) Int. Cl. G06F 3/033

(52) U.S. Cl. 345/179

(57) ABSTRACT

A writing or drawing tip device for attachment to a touch screen stylus or handle has a rigid body of conductive material with a forward end mandrel having a rounded or elliptical tip, at least one layer of compressible material extending over the tip to produce a deformable rounded tip, and a retaining device which secures the compressible layer to the body at a location to the rear of the rounded tip. The deformable tip is applied to a touch screen to develop a contact patch between the compressible material layer and screen sufficient to trigger an input on the screen, with the amount of force applied to the tip determining the size of the contact patch.

### BACKGROUND

1. Field of the Invention

The present invention generally relates to a stylus or pen-like device used to input commands, hand written text or drawings on a touch screen of devices such as cell phones, personal digital assistants, video games, computers, and the like, and is particularly concerned with a tip for a touch screen stylus.

2. Related Art

Touch screen panels detect touching of the screen surface by a user's finger or a stylus to enable entry of commands. A stylus is generally required for writing or drawing on such panels, but existing devices are not sufficiently accurate for technical drawing, and also do not provide good feel or feedback for writing or drawing. There are several types of touch screen device, including resistive and capacitative touch screens. Resistive touch screens have two metal layers separated by a narrow gap. Touching the screen with a finger or writing instrument causes the layers to come into contact at the point where the screen is touched, which is registered as an input by the controller. A capacitative touch screen has an insulative layer such as glass coated with a transparent conductive layer. Touching the surface of the screen with a finger or with a conductive stylus results in a distortion of the screen's electrostatic field, and the resultant change in capacitance is detected as an input by the controller.

Known stylus devices or drawing instruments for input of information onto capacitative or resistive touch screen devices have a conductive pen-like handle or holder, with a tip secured to the end of the handle. The tip is of rigid material with a conductive foam disc adhered to its end. Very little force is required to produce an input on the screen, so there is essentially no feedback or tactile feel through the device to the user. Although this device can be helpful for entering commands or navigating through menus, it is not accurate enough for drawing or writing purposes, due to the lack of feedback through the device. Such devices are not capable of drawing accurate lines and do not give a good tactile feel or feedback for drawing or writing purposes. There is also a risk of scratching the screen if too much pressure is applied so that the foam disc is completely compressed.

### SUMMARY

Embodiments described herein provide for a stylus tip device configured for attachment to a touch screen stylus for more accurate writing or drawing on a touch screen.

In one embodiment, a writing or drawing tip device for attachment to a touch screen stylus or handle has a rigid body of conductive material with a forward end portion or post which has a generally rounded tip, at least one layer of compressible material extending over the tip, and a retaining device or sleeve which secures the compressible layer to the body at a location to the rear of the rounded tip whereby the compressible material layer is trapped between the retaining sleeve and the body of the stylus to the rear of the tip but is not physically adhered to the tip itself. The tip can easily be applied to a touch screen with sufficient pressure to develop a contact patch between the compressible material layer and screen which is large enough to trigger an input on the screen, with the amount of pressure or applied force determining the size of the contact patch and providing tactile feedback to the user when writing or drawing on the screen.

The compressible layer may be a conductive fabric or foam material, and in one embodiment a second layer or cover layer of conductive or non-conductive material such as fabric or foam material may be located over the first compressible layer, and both layers are secured between the retaining sleeve and rigid body or mandrel to the rear of the elliptical tip.

Other features and advantages of the present invention will become more readily apparent to those of ordinary skill in the art after reviewing the following detailed description and accompanying drawings.

### BRIEF DESCRIPTION OF THE DRAWINGS

The details of the present invention, both as to its structure and operation, may be gleaned in part by study of the accompanying drawings, in which like reference numerals refer to like parts, and in which:

FIG. 1 is a perspective view of one embodiment of a stylus tip device for a touch screen stylus;

FIG. 2 is an exploded perspective view illustrating the components of the tip device of FIG. 1;

FIG. 3 is a longitudinal cross-sectional view of the assembled stylus tip device of FIG. 1;

FIG. 4 is a perspective view similar to FIG. 1 illustrating a contact patch developed when the tip of the device of FIGS. 1 to 3 is pressed against a touch screen;

FIG. 5 is a perspective view of another embodiment of the stylus tip device; and

FIG. 6 is a partial cross-sectional view through an end portion of the stylus tip device of FIG. 5.

### DETAILED DESCRIPTION

Certain embodiments as disclosed herein provide for a stylus tip device for a touch screen such as a capacitative touch screen of a cell phones, personal digital assistants, video games, computers, and the like.

After reading this description it will become apparent to one skilled in the art how to implement the invention in various alternative embodiments and alternative applications. However, although various embodiments of the present invention will be described herein, it is understood that these embodiments are presented by way of example only, and not limitation. As such, this detailed description of various alternative embodiments should not be construed to limit the scope or breadth of the present invention.

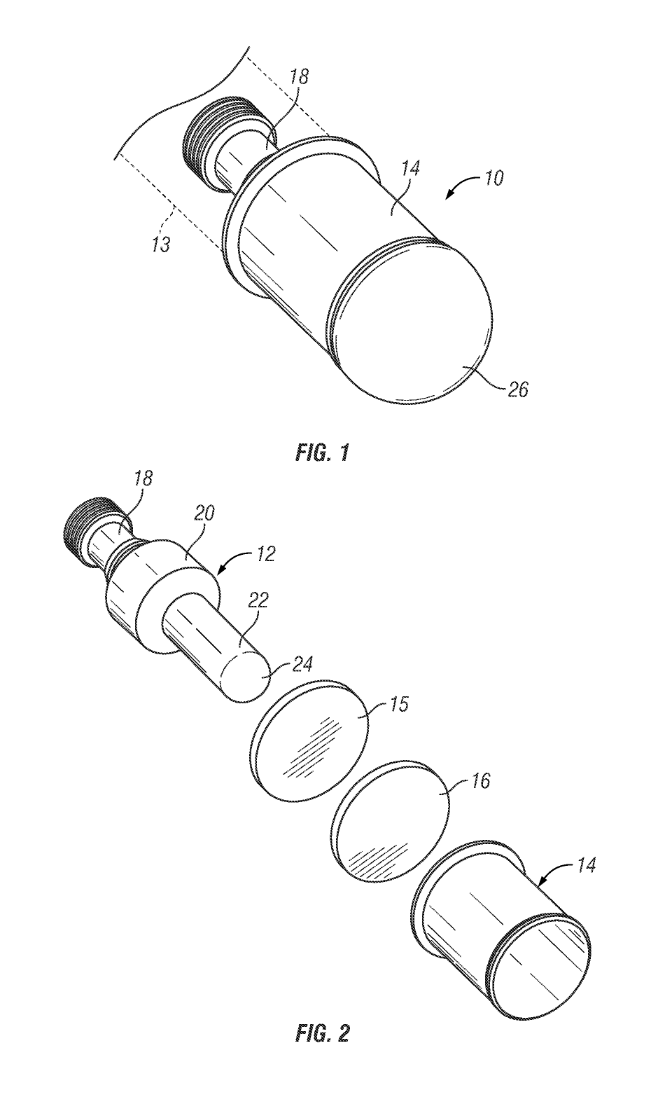

FIGS. 1 to 4 illustrate a first embodiment of a stylus tip device 10 which is attached to a conductive pen or pencil-like body 13 to provide a touch screen stylus. A conventional touch screen handle or pen-like body 13 has a threaded bore or the like at one end for attachment of a tip. The tip device of this embodiment is designed to be secured to such a stylus in place of a conventional tip. As illustrated in the exploded view of FIG. 2, the tip device 10 basically comprises a main body or tip body 12, a retaining sleeve or cap 14, a first layer or disc 15 of pliable, compressible material, and a second layer or disc 16 of the same or a different pliable material. In one embodiment, the first layer is of a compressible conductive fabric or foam material, and the second layer is of a more durable fabric material which may be conductive or non-conductive, and which may also be compressible. Alternatively, layer 15 may be non-conductive while layer 16 is conductive. The main body or mandrel 12 is of a rigid or non-compressible conductive material, and the retention sleeve or cap 14 is of a rigid material such as metal or hard plastic.

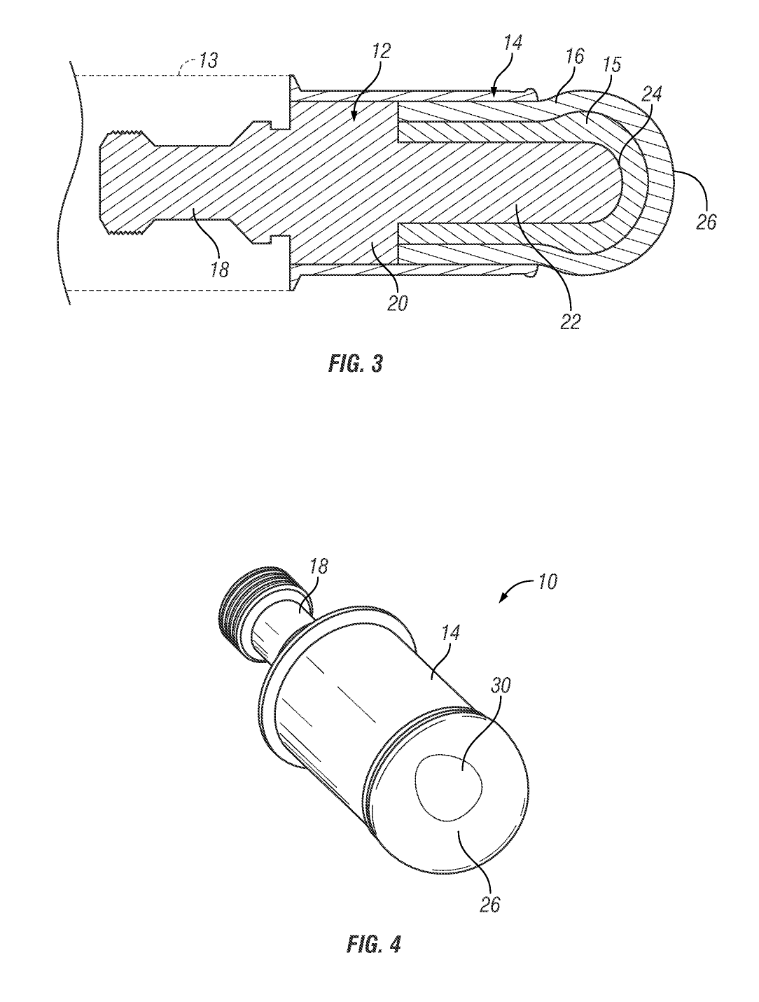

Main body 12 has a first end portion 18 which is shaped for attachment to touch screen stylus or handle 12, an enlarged annular mounting portion 20, and a forward end portion or mandrel 22 of reduced diameter which extends from mounting portion 20 and terminates at a generally rounded, elliptical, or hyperbolic shaped tip 24. Retention cap 14 is a hollow cylindrical member or sleeve which has an internal diameter similar to the outer diameter of cylindrical portion 20, so that the rear end of sleeve 14 is an interference or press fit over mounting portion 20 when the device is assembled as in FIGS. 1 and 3. In alternative embodiments, retention cap 14 and mounting portion 20 may have mateable inner and outer threads, respectively, so that cap 14 can be threadably engaged over portion 20, or adhesive may used to secure these parts together.

In order to assemble the components illustrated in FIG. 2, the two discs are each bent over the forward end portion 22 of the body, and the retention sleeve or cap 14 is then urged rearwardly over the discs until the rear end portion of cap 14 is engaged and press fit over mounting portion 20 of the main body. This traps the outer peripheral portions of the two discs 15, 16 between the opposing outer surface of the forward end portion 22 of body 12 and the inner surface of retention sleeve 14, as best illustrated in FIG. 3. The end result is a deformable, pressure sensitive stylus tip 26 of generally rounded shape, having an outer layer 16 of non-rigid material which may be a compressible fabric, a second or inner layer 15 of compressible foam material, and a rigid inner core or tip 24. The shape of the stylus tip 26 is controlled by the shape of the underlying mandrel tip 24, which may be elliptical, hyperbolic, or parabolic in cross-section, or part-spherical or ball shaped or other generally rounded or radiused shapes in alternative embodiments. The dual layers 15, 16 forming the deformable, pressure sensitive tip are not adhered to one another or to the underlying rigid core or tip 24 of body 12, but are held in place by the retention cap or sleeve 14 which traps and squeezes the rear portions of the two layers between the cap and the end portion 22 of the body.

In this embodiment, the amount of stretch applied to the two discs or layers 15, 16 as they are pulled over the mandrel end portion 22 by sleeve 14 may be varied so as to control the amount of pressure to be applied to the stylus tip in order to produce a contact patch and draw or write on a touch screen. FIG. 4 illustrates a flattened contact patch or area 30 which is produced when deformable tip 26 is applied against a touch screen in order to trigger a change in capacitance sufficient to draw or write on the screen. In one embodiment, the minimum contact patch size required to trigger an event is around 0.015 square inches. This is the approximate surface area of the contact patch needed in one embodiment to complete the connection between the electrical charge of the screen and that of the person holding the stylus. The completion of this connection triggers a capacitance change sufficient to be identified and manipulated by a host processor which controls the display screen. The amount of force or pressure required to produce a contact patch of this size is of the order of 3.5 oz in one embodiment. The force required to activate the screen using this device may be reduced if the user contacts the screen in a secondary, non-event triggering location (for example touching the screen elsewhere with their finger), while simultaneously contacting the capacitative touch screen with the tip 30 of the device. This is known as “boosting” the change in capacitance, and allows the device 10 to be used in a near zero force application of the order of 1.0 oz, with the contact patch size in this case being around 0.011 square inches. The force required to trigger a screen event using the device may be of the order of 1 to 5 oz. Software may be developed in order to translate the contact patch size into line size.

There are various possible combinations of conductive and non-conductive materials which may be used for the various parts of device 10. In each case, the tip body 12 is of conductive material, while either layer or both layers of the pressure sensitive, deformable tip 30 may be of conductive material. At least one of the layers in conductive. Thus, in one embodiment, layers or discs 15, 16 are both of conductive material. In alternative embodiments, layer 15 is conductive while layer 16 is non-conductive, or layer 15 is non-conductive while layer 16 is conductive. The retention sleeve or cap 14 may be of conductive or non-conductive material. Layer 15 may be of open cell conductive foam material. Foam layer 15 may be thicker than the outer layer 16 and have a diameter slightly less than that of layer 16. Layer 16 may be of compressible foam or fabric material. In some embodiments, a single foam layer rather than two layers may be applied over the rigid tip.

The difference between the outer diameter of end portion or mandrel 22 of the tip body 12 and the inner diameter of retention cap or sleeve 14 is less than the combined thickness of the two layers or discs 15, 16 which are sandwiched between the cap and mandrel, so that these layers are compressed and gripped firmly in place when the device is assembled as in FIGS. 1 and 3. The length of sleeve 14 is greater than the length of mandrel or end portion 12, so that a rear end portion of the sleeve can be press fit over the mounting portion 20 while the sleeve still projects forwards over the end portion 12 by a distance sufficient to grip and hold the trapped portions of the two discs or layers 15 and 16, as illustrated in FIG. 3.

In one embodiment, the thickness of the foam layer or disc 15 was around 0.25 inches while the thickness of the cover layer 16 was around 0.12 inches (or 3 mm stock material), so that the combined thickness of both layers in a non-compressed condition was around 0.37 inches. The diameter of layer 15 was around 0.47 inches and the diameter of cover layer 16 was around 0.55 inches. The end portion or mandrel 22 in one embodiment had an outer diameter of 0.11 inches while the cap or sleeve 14 had an inner diameter of around 0.219 inches, and the annular space between these parts when assembled was of the order of 0.10 to 0.12 inches, which is less than the combined thickness of 0.37 inches in the example of layers 15, 16 above. In another embodiment, the tip was larger, with the mandrel or end portion 22 having an outer diameter of 0.14 inches and the cap or sleeve 14 having an inner diameter of the order of around 0.249 inches, but again the thickness of the annular space between the mandrel and sleeve is around 0.10 to 0.12 inches. The dimensions of the two discs used for both the smaller and larger version of the tip may be the same, since the length of the mandrel and of the cap or sleeve 14 is about the same in both the larger and smaller diameter versions. In one embodiment, the length of the enlarged diameter mounting portion 20 was around 0.15 to 0.16 inches, the length of forward end portion or mandrel 22 was around 0.3 inches, and the length of cap or sleeve 14 was around 0.33 inches.

The end or tip 24 is of curved or rounded shape so as to provide for smooth movement over the touch screen while still producing sharp lines on the screen. As noted above, tip 24 of the mandrel may be of part-spherical, elliptical, parabolic, hyperbolic, or radiused shapes. With such shapes, together with the compressible layer or layers stretched over the tip, an event on the screen can be triggered with a minimally sized contact patch at relatively low pressure. This provides similar feedback to a writer, draftsman or artist as they would experience if writing or drawing with standard materials such as pen and paper. In the embodiment of FIGS. 1 to 4, tip 24 is elliptical. In one example, an elliptical tip had a major radius of the order of 0.06 to 0.07 inches, and a minor radius of the order of 0.05 to 0.10 inches.

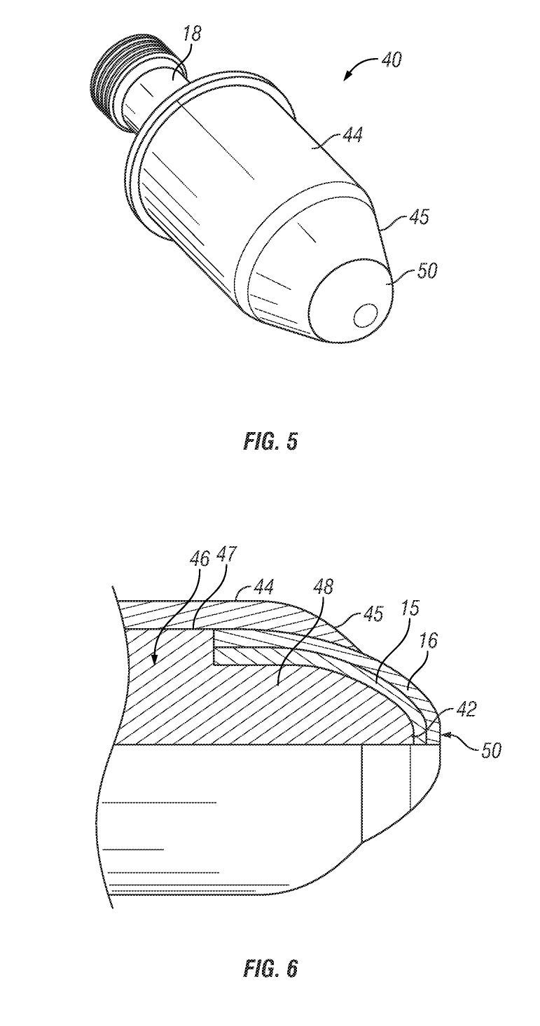

FIGS. 5 and 6 illustrate a second embodiment of a stylus tip device 40 which is similar to the first embodiment but has a differently shaped, rounded mandrel tip 42 and a longer retention sleeve or cap 44 with an inwardly tapered forward end 45 for gripping the sandwiched foam and fabric layers 15, 16. Other parts of the device are similar to those of the first embodiment, and like reference numbers are used for like parts as appropriate. The device 40 comprises a tip body 46 having a rear end portion 18 for attachment to a stylus or the like, an enlarged cylindrical mounting portion 47 and a forward end portion or mandrel 48 with a generally rounded or radiused forward end 42, retention cap or sleeve 44, and first and second layers 15, 16 of different materials stretched over the forward end or tip 42 of the mandrel and trapped between opposing portions of the mandrel and cap 44. The layers 15, 16 adopt substantially the same shape as mandrel tip 42 and provide a deformable, pressure sensitive stylus tip 50 of generally rounded shape. Layers 15, 16 may be of the same relative dimensions and materials as described above in connection with the first embodiment. As in the first embodiment, tip body 45 is designed for attachment to the end of a stylus or pen-like device for holding by a user when writing or drawing on a touch screen, via rear attachment portion 18 which may be threaded or include other engagement formations. Tip body 46 and cap 44 are of rigid or non-compressible material, with tip body 46 being conductive and the retention sleeve being of conductive or non-conductive metal or plastic material.

The tip in this embodiment is applied to a touch screen in the same way as described above in connection with FIGS. 1 to 4, to develop a contact patch of minimum dimensions to activate the processor and produce a corresponding control function or write or draw on the screen.

The stylus tip devices of the above embodiments are designed to provide a deformable, pressure sensitive tip to a touch screen writing or drawing instrument. This provides a more tactile feel when writing or drawing on a touch screen than known types of touch screen stylus tips which generally comprise a foam disc adhered to a tubular pen or pencil-like handle. Due to the part-spherical, elliptical or other rounded shapes of the tip, and the compressible material layer or layers over the rigid tip, the contact patch starts out small and expands as more pressure is applied by the user. The minimum contact patch allows greater accuracy in placement of the device when writing or drawing. The shape of the tip as well as the compressible material used for at least layer 15 and the fact that the portion of layer overlying the rigid tip of the mandrel is not physically adhered to the tip makes it easier to write or draw lines accurately when applying relatively light pressure or force. When boosting the change in capacitance by touching the screen with a finger or a portion of the hand in a non-event triggering location while simultaneously touching the screen with the tip of the device, the device can trigger an event with application of near zero force. This may be used for pointing, clicking and scrolling. When used without boosting, more force is needed and thus feedback is provided through the device to the user to allow writing and drawing on the screen.

Although the tip device described above has a threaded attachment end for engagement with a corresponding threaded end of a pen or pencil-like, hand held stylus in the foregoing embodiments, it may be used as the nib or “lead” for other types of writing and drawing instruments in alternative embodiments. The attachment end portion 18 of the device may be modified as needed for attachment to different standard writing and drawing instruments.

The above description of the disclosed embodiments is provided to enable any person skilled in the art to make or use the invention. Various modifications to these embodiments will be readily apparent to those skilled in the art, and the generic principles described herein can be applied to other embodiments without departing from the spirit or scope of the invention. Thus, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art and that the scope of the present invention is accordingly limited by nothing other than the appended claims.

I claim:

1. A stylus tip device for a touch screen stylus, comprising:
a rigid tip body of conductive material having a rear end and a forward end, the rear end configured for attachment to a handle, and a mandrel extending up to the forward end, the mandrel having a rounded forward tip;
at least a first layer of compressible material covering the tip and at least part of the mandrel of the tip body; and
a retention device securing the compressible material layer to the tip body at a location spaced rearward from the rounded forward tip.

2. The device of claim 1, wherein the tip is at least partially spherical.

3. The device of claim 1, wherein the tip has a rounded, inwardly tapering shape extending up to the forward end.

4. The device of claim 1, wherein the tip has a longitudinal cross-sectional shape selected from the group consisting of elliptical, parabolic, and hyperbolic.

5. The device of claim 1, further comprising a second layer of pliable material secured over the first layer.

6. The device of claim 1, wherein the retention device comprises a hollow sleeve secured over the tip body and configured to trap portions of the compressible material layer between the sleeve and tip body, the sleeve having a forward end spaced to the rear of the rounded forward tip of the body.

7. The device of claim 6, wherein the tip body has an enlarged cylindrical mounting portion, the mandrel comprising a reduced diameter cylindrical portion extending from the mounting portion up to the rounded forward tip, and the hollow sleeve has a rear portion secured to said mounting portion and a forward portion extending over said reduced diameter portion of said mandrel, whereby portions of the compressible material layer are gripped between the mandrel and forward portion of the sleeve.

8. The device of claim 7, wherein the rear portion of the sleeve is an interference fit on the cylindrical mounting portion of the tip body.

9. The device of claim 7, wherein the rear portion of the sleeve is in threaded engagement with the mounting portion of the tip body.

10. The device of claim 7, wherein the rear portion of the sleeve is adhered to the mounting portion of the tip body.

11. The device of claim 7, further comprising a second layer of pliable material extending over the first layer, wherein both layers are gripped between the mandrel and forward portion of the sleeve to the rear of the forward tip of the mandrel.

12. The device of claim 5, wherein the first layer is of foam material.

13. The device of claim 12, wherein the second layer is of fabric or foam material.

14. The device of claim 13, wherein the first layer is thicker than the second layer.

15. The device of claim 5, wherein at least one layer is of conductive material.

16. The device of claim 15, wherein both layers are conductive.

17. The device of claim 15, wherein the tip body is of conductive material.

18. The device of claim 17, wherein the retention device is of non-conductive material.

19. The device of claim 17, wherein the retention device is of rigid plastic or metal.

20. A stylus tip device for a touch screen stylus, comprising:
a rigid tip body of conductive material having a rear end and a forward end, the rear end configured for attachment to a handle, and a mandrel extending up to the forward end, the mandrel having a rounded forward tip;
at least a first layer of compressible material extending over the tip and at least part of the mandrel of the tip body;
the rounded forward tip and compressible material layer together forming a rounded, pressure sensitive, deformable touch screen tip which is configured to flatten and form a contact patch when the rounded tip is applied against a capacitative touch screen, the size of the contact patch increasing with increased force applied by a user of the device; and
the compressible material layer being secured to the tip body at a location spaced rearward from the rounded forward tip and not being secured to the rounded tip.

21. The device of claim 20, wherein the deformable touch screen tip is configured to trigger a capacitative touch screen when sufficient force is applied to the tip to form a contact patch having an area in the range from 0.011 to 0.015 square inches.

22. The device of claim 20, further comprising a second layer of compressible material secured over the first layer.

23. The device of claim 22, wherein at least one of the layers is conductive.

24. The device of claim 23, wherein at least one of the layers is an open cell foam material.

25. The device of claim 23, wherein both layers are of foam material.

26. The device of claim 23, wherein the first layer is of foam material and the second layer is of fabric.

27. The device of claim 22, wherein the first layer has a thickness in the range from 0.2 to 0.3 inches.

28. The device of claim 27, wherein the second layer has a thickness in the range from 0.1 to 0.15 inches.

29. The device of claim 20, wherein the tip is at least partially spherical.

30. The device of claim 20, wherein the tip has a rounded, inwardly tapering shape extending up to the forward tip.

31. The device of claim 20, wherein the tip has a longitudinal cross-sectional shape selected from the group consisting of elliptical, parabolic, and hyperbolic.

32. The device of claim 20, further comprising a retention sleeve securing the first layer to the tip body at a location spaced rearward from the rounded forward tip, the retention sleeve being configured to trap portions of the compressible material layer between the sleeve and tip body, the sleeve having a forward end spaced to the rear of the rounded forward tip of the body.

33. The device of claim 32, wherein the tip body has an enlarged cylindrical mounting portion, the mandrel has a reduced diameter cylindrical portion extending forwards from the mounting portion up to the rounded forward tip, and the hollow sleeve has a rear portion secured to the mounting portion and a forward portion extending over the reduced diameter portion of the mandrel, whereby portions of the compressible material layer are gripped between the mandrel and forward portion of the sleeve.

34. The device of claim 33, wherein the rear portion of the sleeve is an interference fit on the cylindrical mounting portion of the tip body.

35. The device of claim 33, further comprising a second layer of pliable material extending over the first layer, wherein both layers are gripped between the mandrel and forward portion of the sleeve to the rear of the forward tip of the mandrel.
